(19) United States
(12) Patent Application Publication
(10) Pub. No.: US 2005/0261976 A1
(43) Pub. Date: Nov. 24, 2005

(54) Portable information terminal device, merchandise marketing system, method of marketing merchandise, and computer program

(75) Inventor: Keiichi Suzuki, Tokyo (JP)

Correspondence Address: GREENBLUM & BERNSTEIN, P.L.C., 1950 ROLAND CLARKE PLACE, RESTON, VA, 20191, US

(73) Assignee: DWANGO CO., LTD., Tokyo (JP)

(21) Appl. No.: 10/950,441

(22) Filed: Sep. 28, 2004

(30) Foreign Application Priority Data
Apr. 30, 2004 (JP) 2004-135781

(51) Int. Cl. G06G 1/12

(52) U.S. Cl. 705/24; 705/21

(57) ABSTRACT

A portable information terminal device is capable of automatically linking with a marketing site whenever a user desires to purchase merchandise connected with an incoming call melody. The portable terminal internally stores incoming call melody data corresponding to an incoming telephone call event and also stores URL data transmissible to a merchandise marketing server that markets merchandise connected with an incoming call melody data downloaded via an accessed contents server. When an incoming telephone call event occurs, the portable terminal reads out incoming call melody data corresponding to the generated event so as to play incoming call melody. After the call is terminated, the portable terminal outputs a previously stored selective message on a display screen so as to enable the user to choose whether he/she would purchase merchandise connected to the incoming call melody. If the user chooses the purchase of a relevant merchandise, a specific URL data corresponding to the incoming call melody data is read out and linked with a web page within the merchandise marketing server designated by the URL data.

The present invention relates to subject matter contained in Japanese Patent Application No. 2004-135781, filed on Apr. 30, 2004 the disclosure of which is expressly incorporated herein by reference in its entirety.

### BACKGROUND OF THE INVENTION

1. Field of the Invention

The present invention relates to a portable (mobile) information terminal device, a system for marketing merchandise, a method of marketing merchandise, and a computer program, via an inventive function of the portable information terminal device, which enables the user to carry out on-line merchandise purchases.

2. Description of the Prior Art

Conventionally, it has widely been practiced that individual users of portable information terminal devices such as mobile telephones download data of a melody of their favorite music tunes by retrieving relevant data from a server unit, and then arrange their mobile telephones so as to actuate the downloaded melody whenever an incoming call is generated, thereby enjoying the actuated melody. In connection with this prior art, an example is disclosed in Japanese Published Unexamined Patent Application

### SUMMARY OF THE INVENTION

According to any of the conventional arts, whenever an individual user desires to purchase a compact disc, initially, the user is obliged to have a marketing site engaged in on-line marketing linked with an internet service so as to enable retrieval of relevant data from the server unit. However, inasmuch as this procedure involves much complexity, the above conventional procedure fails to effectively guide individual users to an on-line marketing site.

Accordingly, the present invention has been provided and designed so as to fully solve the above problem. The object of the present invention is to provide a novel portable information terminal device, which enables its user to readily access an objective marketing site whenever the user desires to purchase merchandise without obliging the user to retrieve the relevant data from a server unit. In addition to the novel portable information terminal device, the present invention further provides a novel merchandise marketing system, which enables users to be guided to an objective or desired marketing site effectively.

The present invention has been achieved in light of a tendency shown in terms of a user's inclination to purchase specific merchandise at the moment of receiving an incoming call melody or an incoming image.

According to an aspect of the present invention, a portable information terminal device is provided, which includes a memory for storing contents data in correspondence with an incoming event. A contents output, which, upon occurrence of an incoming call event, reads from the memory the contents data corresponding to the incoming event and then externally outputs the contents data. A contents acquirer accesses a contents server unit that distributes contents data via a network and acquires the contents data and reference information necessary for designating a marketing site that markets merchandise pertaining to the contents data. A contents memory enables the memory to internally store the contents data and the reference information acquired via the contents acquirer. A selective message output device, which, after causing the contents output to output the contents data and further enabling a user to complete a predetermined confirming process, causes a selective message to be output to a display screen so as to enable the user to choose whether or not a merchandise related to the contents data should be purchased. A linker, which, upon receipt of instructions pertaining to the selection of one of the selective messages, reads the reference information corresponding to the contents data from the memory and enables the contents data to be linked via the network with the marketing site designated by the reference information.

Further, the contents data corresponding to the incoming call event includes an incoming call melody, the predetermined confirming process includes one of a telephone calling process and a mail confirming process, the marketing site includes a site for marketing musical media including musical tunes related to the incoming call melody. The contents data corresponding to an incoming call event comprises incoming animation data; the predetermined confirming process includes one of a telephone calling process and a mail confirming process and the marketing site includes a site for marketing video media including movies related to the incoming animation.

Another aspect of the invention relates to a merchandise marketing system which includes a portable information terminal device that includes a contents server, which stores a variety of contents data, a merchandise marketing server, which serves for marketing merchandise corresponding to the contents data, and an incoming call event storing memory, which stores the contents data in correspondence with an incoming call event. Upon the occurrence of an incoming call event, the portable information terminal device reads the contents data corresponding to the incoming call event from the incoming call event storing memory and externally outputs the contents data. The portable information terminal device, the contents server unit, and the merchandise marketing server unit are connected to a network. The contents server unit includes a first memory, which enables the contents data memory to store reference information for designating a web page in the merchandise marketing server that markets merchandise related to the contents data. A contents data distributor, which, after being accessed by the portable information terminal device via the network, reads the requested contents data and reference information from the contents data memory so as to distribute the read-out contents data and reference information. The portable information terminal device includes a contents acquirer, which, upon receipt of the instructions of a user, accesses the contents server via the network, and acquires the contents data and reference information from the contents server. A second memory, which enables the contents data acquired by the contents acquires and the reference information to be stored in the incoming call event storing memory in correspondence with individual incoming call events. A selective message output, which, upon the output of the contents data read from the incoming call event storing memory in response to the occurrence of the incoming call event and after enabling a user to complete a predetermined confirming process, causes a selective message to be output to a display screen so as to enable the user to choose whether or not merchandise related to the contents data should be purchased. A linker, which, upon receipt of the instructions of a user for choosing one of the selective messages, reads the reference information corresponding to the contents data from the incoming call event storing memory and causes the contents data to be linked with a web page of the merchandise marketing server. The merchandise marketing server further includes a web page responder, which generates a response with respect to the information stored on the web page corresponding to the reference information in response to the receipt of a request including the reference information from the portable information terminal device.

A further aspect of the invention relates to a method of marketing merchandise via a merchandise marketing system that includes a portable information terminal device having a contents server, which stores contents data. A merchandise marketing server, which markets merchandises pertaining to the contents data. An incoming call event storing memory, which stores the contents data in correspondence with individual incoming call events. In response to the occurrence of an incoming call event, the portable information terminal device reads the contents data corresponding to the incoming call event from the incoming call event storing memory. The merchandise marketing system is further connected to a network, to which the portable information terminal device, the contents server unit, and the merchandise marketing server unit are connected.

The merchandise marketing method includes causing the contents server to store reference information referring to a web page in the merchandise marketing server into a contents data memory, wherein the merchandise marketing server markets merchandise pertaining to the contents data. The portable information terminal device is caused to access the contents server via the network upon receipt of instructions from a user. The contents server is accessed by the portable information terminal device and reads the requested contents data and reference information from the contents data memory to distribute the read-out contents data and referred information. The portable information terminal device acquires the contents data and reference information from the contents server and stores the contents data and reference information in the incoming call event storing memory in correspondence with individual incoming call events. A selective message is output to a display screen so as to enable a user to choose whether or not merchandise related to the contents data should be purchased after enabling the user to complete a predetermined confirming process, the contents data have been read out from the incoming call event storing memory in response to the occurrence of an incoming call event. The portable information terminal device is caused to read out the reference information corresponding to the contents data from the incoming call event storing memory upon receipt of the user's instructions indicating that the user has chosen the selected message, and causing the contents data to be linked with the web page of the merchandise marketing server designated by the reference information. The merchandise marketing server unit generates a response regarding the information of the web page corresponding to the reference information, when a request including the reference information has been received from the portable information terminal device.

An additional aspect of the present invention relates to a computer program for enabling a computer in a portable information terminal device. The computer includes a memory for storing contents data in correspondence with individual incoming call events, and a contents output, which reads out the contents data corresponding to the incoming call event in response to the occurrence of an incoming call event from the memory before externally outputting the contents data. The computer in the portable information terminal device executes the computer program which includes a contents acquiring code segment, which accesses a contents server that distributes contents data via a network so as to acquire the contents data and reference information for designating a marketing site that markets merchandise related to the contents data. A contents memory code segment enables memory to store the contents data and reference information acquired by the contents acquiring code segment. A selective message output code segment causes a selective message to be output to a display screen so as to enable a user to choose whether merchandise relevant to the contents data should be purchased after enabling the user to complete a predetermined confirming process after output of the contents data via the contents output code segment. A linking code segment, upon receipt of the instructions indicating that the user has chosen the selective message, reads the reference information corresponding to the contents data from the memory and links the contents data with the marketing site designated by the reference information via the network.

According to the present invention, the above portable information terminal device and the merchandise marketing system jointly enable a user to easily be linked with a merchandise marketing site without spontaneously retrieving an objective site on an internet service line, thereby generating a satisfactory effect in smoothly guiding the user to a desired marketing site.

### BRIEF DESCRIPTION OF THE DRAWINGS

FIG. 1 presents a schematic block diagram designating a portable information terminal device and a merchandise marketing system according to an embodiment of the present invention;

FIG. 2 presents a pair of block diagrams respectively designating configurations of various data stored in a contents server unit and a portable information terminal device according to the embodiment;

FIG. 3 presents a flowchart for designating a series of steps of processes executed by the portable information terminal device according to the embodiment; and

FIG. 4 presents an example of the contents of a display screen of the inventive portable information terminal device according to the embodiment.

### DETAILED DESCRIPTION OF THE PREFERRED EMBODIMENTS

Referring to the accompanying drawings, the portable information terminal device and the merchandise marketing system according to an embodiment of the present invention are described below.

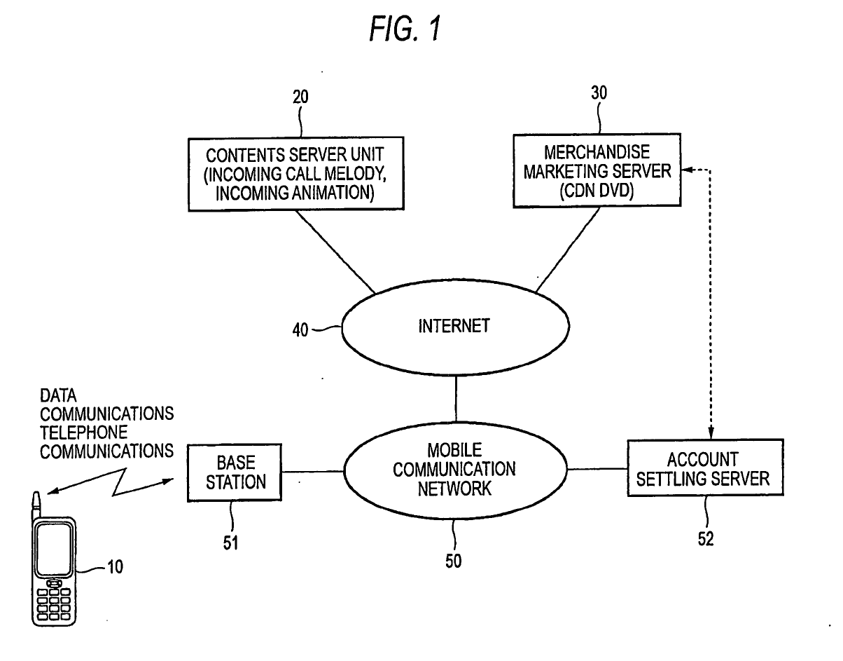

FIG. 1 presents a schematic block diagram designating a merchandise marketing system according to an embodiment of the present invention. In FIG. 1, a reference numeral 10 designates a portable telephone unit available to a user. However the present invention is not limited to a telephone but is applicable also to any wireless communicating device, such as a personal digital assistant or the like. The portable telephone device 10 is linked with a base station 51 of a mobile communications operator via wireless communications to enable executing telephone communications and/or a data communications via a mobile communications network 50 and an internet 40. A contents server unit 20 is linked with the internet 40 storing incoming call melody data and animation data, and transmits incoming call melody data or animation data in response to a request from the portable telephone device 10. A merchandise marketing server unit 30 executes on-line marketing of merchandise comprising video media corresponding to musical media and/or animation including musical tunes corresponding to the incoming call melodies. It should be noted that the term “musical media” includes, as non-limiting examples, a compact disc (CD), a mini disc (MD), and a magnetic audio tape, whereas the term “video media”, as non limiting examples, includes a digital versatile disc (DVD) and a magnetic video tape. Whenever marketing any merchandise in response to the request from the above portable information terminal device 10, the merchandise marketing server unit 30 executes a procedure for settling the account for the purchase of merchandise from the designated telephone charge payable account owned by the user of the portable information terminal device 10 by way of linking itself with an account settling server unit 52 on a part of the designated mobile communications operator. Further, while the present invention is described with respect merchandise purchases it can also be applied to other situations, such as charitable contributions.

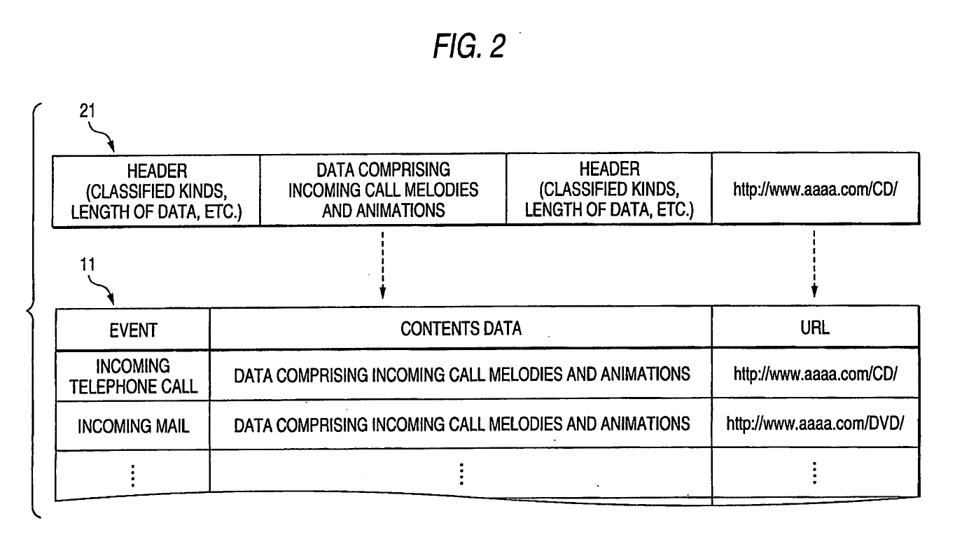

FIG. 2 exemplifies a typical configuration of various data stored in a contents data base 21 including a variety of incoming call melodies stored in the contents server unit 20 and another configuration of various data stored in another data base 11 corresponding to each event when these data are internally accommodated after causing the portable information terminal device 10 to download them from the contents server unit 20 in response to the user's instructions.

The contents data base 21 is configured with header information including a classification of the kinds of data and the length of data, which are combined with various data shown in the header information. The stored data include not only the incoming call melodies and animations, but also URL (Uniform Resource Locator) data released by the merchandise marketing server unit 30, for example.

On the other hand, the other event corresponding data base 11 is arranged to store data in correspondence with an event such as incoming telephone calls and incoming mails. As used herein the term mail refers to electronic mail i.e., e-mail. Kinds of data corresponding to individual events include incoming call melodies and animations stored in the contents data base 21 and the URL data of the merchandise marketing server unit 30. After setting data in the event corresponding data base 11, whenever any event including an incoming telephone call or an incoming mail has been generated, the portable information terminal device 10 reads contents data corresponding to the occurred event, and then outputs the read-out data in the form of an incoming call melody or animation.

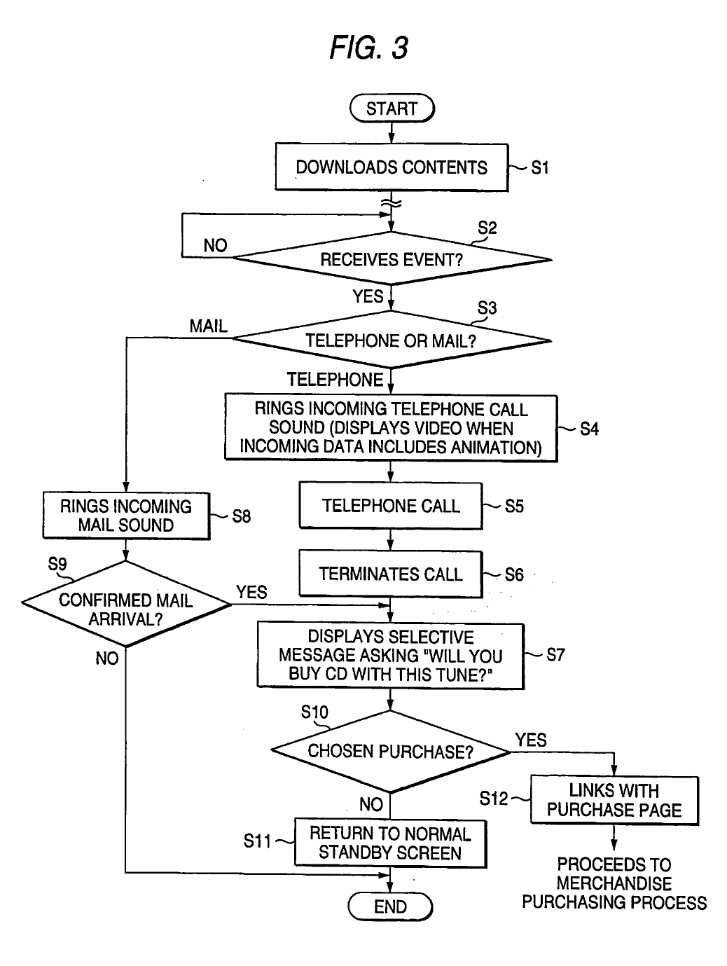

FIG. 3 presents a flowchart designating flow of serial processes ranging from an initial step enabling the portable information terminal device 10 to download contents data including incoming call melodies and the URL data in response to the user's instructions and then set them internally up to a step at which a user commences purchase of merchandise after enabling the portable information terminal device 10 to automatically read the URL data subsequently to the occurrence of an event in the form of an incoming telephone call or an incoming mail.

Initially, step S1 is entered, in which a user accesses the contents server unit 20 so as to retrieve his/her favorite contents such as an incoming call melody for example, and then downloads the retrieved contents before eventually setting the detected contents into event corresponding data base 11. Next, step S2 is entered, in which the portable information terminal device 10 is in standby mode until receiving an incoming call event such as an incoming telephone call or an incoming mail. Upon reception of an incoming event, the following step S3 is entered, in which it is identified whether the generated event corresponds to an incoming telephone call or an incoming mail. If the event was caused by an incoming telephone call, then step S4 is entered, in which the portable information terminal device 10 reads out a contents data corresponding to an incoming telephone call event, i.e., an incoming call melody data, from the event corresponding data base 11, and then generates the designated melody. Next, the user depresses a call button and then conducts a call while step S5 is underway. For example, when the user terminates a call by depressing a ring-off button, step S6 is entered. Next, step S7 is entered, in which a selective message such as “will you buy this CD recorded with this tune?” is output on a display screen. If it is so arranged that an animation data is externally output at the time of receiving an incoming call, another selective message such as “will you buy this DVD recorded with this movie?” discretely prepared in advance will be displayed on the display screen. These selective messages are individually linked with a URL data read out from the event corresponding data base 11. Accordingly, by enabling a user to choose either of the selective messages, the selected message is linked with the merchandise marketing server unit 30 in the manner automatically following the URL data.

On the other hand, if the incoming event was identified to be an incoming mail event at step S3, then step S8 is entered, in which a contents data corresponding to the mail arrival mode is read out from those events corresponding data base 11 and then externally output. When the user depresses a button for confirming the arrival of the mail, the above process corresponding to step S7 are executed, thereby causing the above-referred selective menu to appear on the display screen. If the user does not depress the button for confirming the arrival of a mail, then, at step S9, in which it is identified that the user fails to refer to the display screen, thereby terminating the series of processes without displaying either of the above-referred messages.

Next, after step S7, step S10 is entered, in which it is identified whether the user has chosen the message that was displayed on the screen while step S7 was underway, or not. If this message was not chosen, then, step S11 is entered, in which the operating mode is switched over to the normal standby mode on the display screen after the elapse of a specific period of time, thus terminating the above serial processes. Conversely, if either of the above messages were chosen, then, step S12 is entered, in which the selected message is linked with a web page corresponding to the merchandise marketing server unit 30 in conformity with the URL data corresponding to the selected message, and then a procedure required for purchasing merchandise is executed.

Inasmuch as the URL data for transmission to the merchandise marketing server unit 30 is directly linked with a specific web page for purchasing the intended merchandise without being linked with an upper web page of the merchandise marketing server unit 30, the user is enabled to instantaneously commence a procedure for purchasing the intended merchandise without necessarily retrieving merchandises within the merchandise marketing server unit 30.

As a result of executing the above procedure, by merely choosing either of the selective messages displayed on the screen, the user is enabled to have merchandise relevant to the desired contents linked with a site for the marketing of the desired merchandise, thus making it possible to purchase the intended merchandise via an on-line service without spontaneously retrieving an objective site dealing with the desired contents, after visually or audibly identifying the contents output at the time of generating the incoming call event.

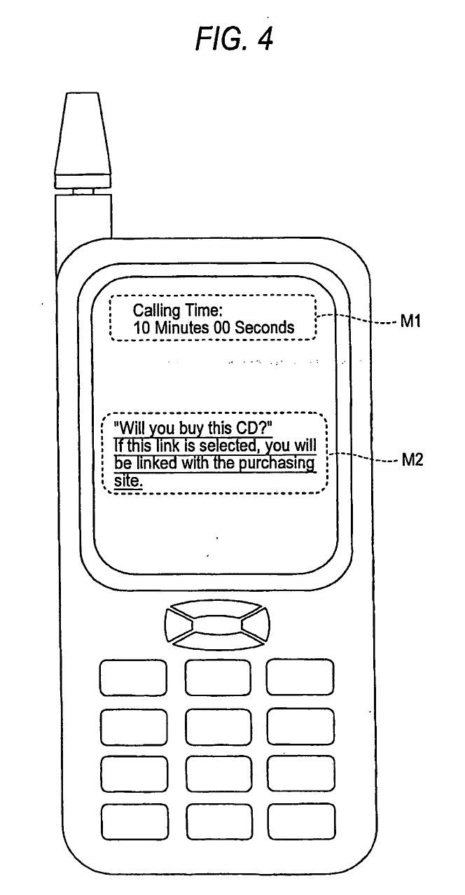

FIG. 4 illustrates an example of the display screen while step S6 is underway as shown in FIG. 3. The message M1 designates the actual duration of the telephone call, which is normally displayed on the screen at the time of terminating the telephone call when operating any conventional portable information terminal device. The other message M2 encourages the user to purchase a CD. When the user has chosen this message, in accordance with the URL data corresponding to the selected message, the portable information terminal device 10 is linked with the merchandise marketing server unit 30.

The above portable information terminal device incorporates a computer system. The routines including a step of downloading contents data comprising an incoming call melody, for example, in conjunction with the URL data, a step of internally setting the downloaded data, and a step of reading the URL data after generation of an incoming call event or an incoming mail event so as to purchase merchandise, are serially stored in a computer-readable recording medium in the form of a program. These processes are executed by causing the built-in computer to read this program and implement the programmed serial steps described above. The computer-readable recording medium includes a magnetic disc, a magneto-optical disc, a CD-ROM, a DVD-ROM, and a semiconductor memory, or the like. Note that, it is also possible to cause a built-in computer to execute the above program after distributing the computer program to this computer via a communications circuit.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with the reference to particular structures, materials and embodiments, the present invention is not intended to be limited to the particulars disclosed herein; rather, the present invention extends to all functionally equivalent structures, methods and uses, such as are within the scope of the appended claims.

1. A portable information terminal device comprising;
a memory for storing contents data in correspondence with an incoming event; and
a contents output, which, upon occurrence of an incoming call event, reads from the memory the contents data corresponding to the incoming event and then externally outputs the contents data;
a contents acquirer, which accesses a contents server unit that distributes contents data via a network and acquires the contents data and reference information necessary for designating a marketing site that markets merchandise pertaining to the contents data;
a contents memory, which enables said memory to internally store the contents data and the reference information acquired via the contents acquirer;
a selective message output device, which, after causing the contents output to output said contents data and further enabling a user to complete a predetermined confirming process, causes a selective message to be output to a display screen so as to enable the user to choose whether or not a merchandise related to said contents data should be purchased; and
a linker, which, upon receipt of instructions pertaining to the selection of one of the selective messages, reads the reference information corresponding to said contents data from the memory and enables said contents data to be linked via the network with the marketing site designated by the reference information.

2. A portable information terminal device according to claim 1, wherein the contents data corresponding to the incoming call event comprises an incoming call melody; wherein the predetermined confirming process comprises one of a telephone calling process and a mail confirming process; wherein the marketing site comprises a site for marketing musical media including musical tunes related to the incoming call melody.

3. A portable information terminal device according to claim 1, wherein said contents data corresponding to an incoming call event comprises incoming animation data; wherein the above predetermined confirming process comprises one of a telephone calling process and a mail confirming process; wherein the marketing site comprises to a site for marketing video media including movies related to the incoming animation.

4. A merchandise marketing system comprising;
a portable information terminal device comprising;
a contents server, which stores a variety of contents data;
a merchandise marketing server, which serves for marketing merchandise corresponding to said contents data; and
an incoming call event storing memory, which stores said contents data in correspondence with an incoming call event; wherein, upon the occurrence of an incoming call event, the portable information terminal device reads the contents data corresponding to the incoming call event from the incoming call event storing memory and externally outputs said contents data; and
a network, to which said portable information terminal device, said contents server unit, and said merchandise marketing server unit are connected;
wherein the contents server unit comprises:
a first memory, which enables said contents data memory to store reference information for designating a web page in said merchandise marketing server that markets merchandise related to the contents data; and
a contents data distributor, which, after being accessed by the portable information terminal device via the network, reads the requested contents data and reference information from the contents data memory so as to distribute the read-out contents data and reference information;
wherein the portable information terminal device comprises;
a contents acquirer, which, upon receipt of the instructions of a user, accesses the contents server via the network, and acquires the contents data and reference information from the contents server;
a second memory, which enables the contents data acquired by the contents acquires and the reference information to be stored in the incoming call event storing memory in correspondence with individual incoming call events;
a selective message output, which, upon the output of the contents data read from the incoming call event storing memory in response to the occurrence of the incoming call event and after enabling a user to complete a predetermined confirming process, causes a selective message to be output to a display screen so as to enable the user to choose whether or not merchandise related to said contents data should be purchased; and
a linker, which, upon receipt of the instructions of a user for choosing one of the selective messages, reads the reference information corresponding to the contents data from the incoming call event storing memory and causes the contents data to be linked with a web page of the merchandise marketing server;
wherein the merchandise marketing server further comprises a web page responder, which generates a response with respect to the information stored on the web page corresponding to the reference information in response to the receipt of a request including the reference information from the portable information terminal device.

5. A method of marketing merchandise via a merchandise marketing system, the merchandise marketing system including:
a portable information terminal device comprising;
a contents server, which stores contents data;
a merchandise marketing server, which markets merchandises pertaining to the contents data; and
an incoming call event storing memory, which stores the contents data in correspondence with individual incoming call events;
wherein, in response to the occurrence of an incoming call event, the portable information terminal device reads the contents data corresponding to the incoming call event from the incoming call event storing memory;
wherein the merchandise marketing system is further connected to a network, to which the portable information terminal device, the contents server unit, and the merchandise marketing server unit are connected;
wherein the merchandise marketing method comprises:
causing the contents server to store reference information referring to a web page in the merchandise marketing server into a contents data memory, wherein the merchandise marketing server markets merchandise pertaining to the contents data;
causing the portable information terminal device to access the contents server via the network upon receipt of instructions from a user;
accessing the contents server by the portable information terminal device and reading the requested contents data and reference information from the contents data memory to distribute the read-out contents data and referred information;
acquiring, by the portable information terminal device, the contents data and reference information from said contents server and storing the contents data and reference information in the incoming call event storing memory in correspondence with individual incoming call events;
outputting a selective message to a display screen so as to enable a user to choose whether or not merchandise related to the contents data should be purchased after enabling the user to complete a predetermined confirming process the contents data have been read out from the incoming call event storing memory in response to the occurrence of an incoming call event;
causing the portable information terminal device to read out the reference information corresponding to the contents data from the incoming call event storing memory upon receipt of the user's instructions indicating that the user has chosen the selected message, and causing the contents data to be linked with the web page of the merchandise marketing server designated by the reference information;
generating, by the merchandise marketing server unit, a response regarding the information of the web page corresponding to the reference information when a request including the reference information has been received from the portable information terminal device.

6. A computer program for enabling a computer in a portable information terminal device; the computer comprises a memory for storing contents data in correspondence with individual incoming call events; and a contents output, which reads out said contents data corresponding to the incoming call event in response to the occurrence of an incoming call event from the memory before externally outputting the contents data;
wherein the computer in the portable information terminal device executes the computer program comprising:
a contents acquiring code segment, which accesses a contents server that distributes contents data via a network so as to acquire the contents data and reference information for designating a marketing site that markets merchandise related to said contents data;
a contents memory code segment, which enables memory to store said contents data and reference information acquired by the contents acquiring code segment;
a selective message output code segment, which causes a selective message to be output to a display screen so as to enable a user to choose whether merchandise relevant to the contents data should be purchased after enabling the user to complete a predetermined confirming process after output of the contents data via the contents output code segment; and
a linking code segment, which, upon receipt of the instructions indicating that the user has chosen the selective message, reads the reference information corresponding to said contents data from the memory and links the contents data with the marketing site designated by the reference information via the network.
